(19) United States
(12) Patent Application Publication
(10) Pub. No.: US 2015/0001761 A1
(43) Pub. Date: Jan. 1, 2015

(54) METHOD AND APPARTUS FOR MOULDING

(71) Applicant: BBM TECHNOLOGY LTD., London (GB)

(72) Inventors: Graham John Bratton, Kent (GB); Roger Leslie Brown, London (GB)

(73) Assignee: BBM Technology Ltd, London (GB)

(21) Appl. No.: 14/378,276

(22) PCT Filed: Feb. 14, 2013
(86) PCT No.: PCT/GB2013/050354

§ 371 Date: Aug. 12, 2014

(30) Foreign Application Priority Data
Feb. 14, 2012 (GB) 1202538.3

(51) Int. Cl. B28B 1/14; B29C 33/00; B28B 1/00

(52) U.S. Cl. CPC B28B 1/14; B28B 1/004; B29C 33/0088; B29K 2823/0633
USPC 264/299; 249/187.1

(57) ABSTRACT

In the moulding of cementitious articles, a flexible plastics mould e.g. of LDPE may be used to permit de-moulding of the articles e.g. by flexion of the mould. Moulds filled with hydraulically settable material may be supported in frames configured e.g. with plug and socket formations on upper and lower faces for cooperation with moulds to retain them in position and for cooperation with overlying and underlying frames to permit stacking.

The present invention relates to the moulding of shaped articles from cementitious or other settable materials. It also relates to a flexible plastics mould that may be used to permit de-moulding of the articles while in a green state and to support frames for moulds filled with cement paste configured for cooperation with the moulds to retain them in position and for cooperation with overlying and underlying frames to permit stacking e.g. in a chamber where the moulds may be maintained for a desired curing time at a predetermined elevated temperature and relative humidity.

### BACKGROUND TO THE INVENTION

Polyurethane rubber may be brushed, poured or sprayed onto a model to form a mould which may then be used for casting shaped articles in a number of materials including concrete and may be used to make architectural elements, concrete stone veneer, form liners, concrete countertops, GFRC panels, concrete statues and furniture. Materials available from Smooth-On (www.smooth-on.com) for that purpose include Vyta-Flex urethane rubber available in grades from 10A to 60A Shore hardness

It is known to cast cementitious materials using moulds of polyurethane rubber e.g. the PMC-121 series of elastomeric mould-forming materials available from Smooth-on including Vyta-Flex and Brush-On elastomers available in grades from 10 to 60 Shore A hardness. The polyurethane elastomers used are relatively expensive and require at least 16 hours at ambient temperatures to cure, preferably followed by post-curing at 65° C. for 4-8 hours to improve the physical properties and performance of the resulting mould. A rigid support shell or so-called “mother mould” may be needed to support the resulting mould during casting. Casting of cementitious articles cannot be carried out without the use of a release agent which not only adds a step to the casting process but can give rise to irregularities in the cast product if the release agent is not applied uniformly and also precludes use of cast products e.g. of the type disclosed in WO 2009/019512 in the food industry.

Conventional high volume cementitious paste casting moulds are manufactured from alloy materials that are rigid and require complex and expensive ejector mechanisms or dismantleable mould pieces. Owing to the length of time required for curing cement, if continuous manufacturing is to be performed then a large number of moulds is necessary, often three times the number of articles to be moulded per cycle. In order to ensure clean ejection, alloy moulds often require PTFE or similar coatings that abrade with use. Such moulds require off-site recoating and refurbishment which either necessitates yet further moulds to be manufactured or process closedown whilst refurbishment is carried out. If the shape of the intended moulded article has to be changed then a correspondingly large number of moulds have to be changed or replaced. The high capital cost and on-going maintenance and management of change associated with alloy moulds restricts the use of cementitious materials and increases the product cost to the customer.

For example, in the building industry it is known from UA 2011/0041448 (Ciccarello) to make a cast concrete stone by a dry-cast concrete mould wherein a profiling plate is provided with mould bottom wall formations each having a textured outer surface. A bond release film or spray or permanent coating is provided on the textured outer surface of the mould bottom wall formations. Mould forming side walls are disposed about the mould bottom wall formations. After the mould is filled with a dry-cast concrete mixture a top plate, having mould top wall formations, is disposed over the mould forming side walls with the mould top wall formations disposed inside respective ones of the moulds to close the moulds. Pressure and vibration is applied to compact the dry-cast concrete whereby to form a dry-cast concrete stone with opposed moulded textured surfaces, see also e.g. US 2004/0104511 (Griffith) and 2008/0174041 (Firedman).

### SUMMARY OF THE INVENTION

In an embodiment the present invention is concerned with the casting or moulding of shaped articles of cementitious or other hydraulically settable materials often is masses ≧50 g and often so as to have a high surface area to volume ratio. Shaped articles may have masses e.g. of ˜300 g, e.g. ≧500 g, some embodiments ≧1 kg, e.g. ≧3 kg. Such articles in embodiments may be generally planar with at least one through hole, e.g. 10-40 through holes e.g. 15 through holes. In some embodiments the shaped articles have a mass of 265-295 g, nominally 280 g, SD of 4.2. In other embodiments e.g. for use in fryers holding up to 3 litres of oil, shaped articles of lesser mass e.g. about 80 g may be appropriate.

The invention provides a method for casting a shaped article from hydraulically settable material which includes the steps of: introducing the hydraulically settable material into a mould and allowing it to harden at least to a green state; and removing the hardened material from the mould, wherein the mould is of a flexible low surface energy thermoplastics material and removal is by deformation of portions at least of the mould.

In a further aspect the invention relates to the use in the moulding of articles in cement paste of a flexible plastics mould to permit de-moulding of articles whilst in a green state. Embodiments provide a flexible mould that is manufactured from inexpensive plastic materials by injection moulding or vacuum forming techniques and which need only have a limited lifespan. This has the advantages of quick time to market, low unit cost, simple change management through natural wastage, easier cleaning and lower impact on the product cost, enabling products to manufactured at a lower price and in greater variety. Many of the mould plastics can be reground and recycled to manufacture further moulds once they have worn out and been replaced or used for other plastic moulded products. De-moulding may be by deformation e.g. flexion of the mould which may be of LDPE. Articles to be moulded may be of complex shape e.g. having at least two recesses or through-holes for providing surface area and in a generally rectangular embodiment 15 such recesses or through-holes. Other embodiments may be polygonal, oval or circular with recesses or through holes disposed at spaced intervals in a pattern over the articles.

In a yet further embodiment there is provided a frame for supporting a mould for complex shapes in cement paste or slurry, said frame being configured to permit vertical stacking of the plastics moulds. When curing and hydrating products manufactured from cementitious materials within moulds it is necessary to provide a high relative humidity (RH) ambient environment. When the ambient environment is a controlled RH chamber as opposed to just a covering to the mould, it is desirable to provide good access of moist air to the open mould face. When there are a large number of moulds in use this normally requires a large surface area for placement of the moulds such as many shelves, within the chamber creating handling problems in terms of manual movement into the chamber, layout on the shelves and similar issues when removing from the chamber.

Further embodiments provide an interlocking stacking separator frame that allows vertical placement of one mould upon another whilst still permitting good air circulation around the open mould faces. In embodiments the separator has plug and socket formations on opposed upper and lower faces for cooperation with overlying and underlying frames of a stack. Such features may include formations for cooperation with formations of the mould for retaining a mould in position therein, e.g. the frame may have pegs for locating in apertures of the mould. The frames may be of plastics material and may be an injection moulding or is vacuum formed.

There is also provided a stack comprising flexible plastics moulds to permit de-moulding of articles whilst in a green state and frames for supporting the moulds, said frames being configured to stand one on another and permit vertical stacking of the plastics moulds.

In a further embodiment the invention relates to the casting or otherwise forming of a shaped article from a settable material requiring a flexible mould for ease of release which includes the steps of:

introducing the settable material into a mould and allowing it to harden; and

removing the hardened material from the mould,

wherein the mould is of a flexible low surface energy thermoplastics material and removal is by deformation of portions at least of the mould.

In embodiments the mould is of a polyalkylene, e.g. polyethylene e.g. LDPE. It may have an open face through which the article is removable after release without further mould deformation. In some embodiments the settable material is hardenable by cooling e.g. an organic thermoplastics material. It may be an inorganic material that is hardenable by curing e.g. a gypsum-based composition. It may be an organic material that is hardenable by curing catalytically or by means of a cross-linking agent e.g. an epoxy resin or a composition based on an epoxy resin. It may be a UV-curable material. The settable material may in some embodiments be solvent-based and in other embodiments water-based. In further embodiments the mould may be used for freeze casting e.g. of near net shape ceramic articles based on e.g. alumina, alumina-zirconia, silica, aluminosilicates, silicon nitride and metal-ceramic mixtures (e.g. zuirconium carbide and tungsten) and biomaterials e.g. bone substitute materials such as hydroxyapatite. Freeze casting in some embodiments involves a rapid freeze step for which the low glass transition temperature of LDPE (−125° C.) is an advantage. By way of background freeze-casting is discussed in U.S. Pat. No. 6,796,366 (Roche, Ford Motor Company).

### BRIEF DESCRIPTION OF THE DRAWINGS

How the invention may be put into effect will now be described by way of example only with reference to the accompanying drawings, in which:

FIG. 1 is a plan view of a mould for moulding articles according to the invention;

FIG. 2 is a section on the mould taken along the line A-A of FIG. 1 and

FIG. 3 is a trimetric top view of the mould;

FIG. 4 is a plan view of the mould place on a stacking frame,

FIG. 5 is a trimetric top view of the stacking frame and

FIG. 6 is a trimetric underneath view of the stacking frame;

FIG. 7 is a side view of a stack of the frames and moulds and

FIG. 8 is a part sectional view of two moulds and two stacking frames; and

FIGS. 9-11 show stages in the de-moulding of a shaped article moulded with a mould of thin injection-moulded plastics sheet material.

### DETAILED DESCRIPTION OF PREFERRED EMBODIMENTS

### Hydraulically Settable Materials

Flexible plastics moulds can be used for the casting of shaped articles in a variety of inorganic hydraulic settable compositions which may consist in their entirety of hydraulically settable material (i.e. in “paste” form) or may employ hydraulically settable material as a binder in combination with other inorganic substances.

Hydraulically settable materials include inorganic materials e.g. hydraulic cement, gypsum hemihydrate, calcium oxide, or mixtures thereof) which develop strength properties and hardness by chemically reacting with water and, in some cases, with carbon dioxide in the air. Examples of known hydraulic cements include the broad family of Portland cements (including ordinary Portland cement without gypsum), high alumina cements, calcium aluminate cements (including such cements without set regulators), silicate cements (including β-dicalcium silicates, tricalcium silicates, and mixtures thereof), magnesium oxychloride cements, geopolymer cements (Pyrament-type cements), macrodefect-free (MDF) cement, densified with small particles (DSP) cement and α-dicalcium silicate which can be made hydraulic under hydrating conditions.

Materials used in embodiments of the invention are hydraulic cements. This means that the materials react with water to form a cementitious reaction product (calcium silicate hydrate (CSH) gel) that acts as “glue” which binds the cement particles together. The most common cement is Portland cement.

Portland cement and Portland cement clinker which may be used herein are made primarily from a calcareous material such as limestone or chalk and from alumina and silica both of which are found in clay or shale. Marl, a mixture of both calcareous and argillaceous materials is also used. The raw materials are ground in a large rotary kiln at a temperature of around 1400° C. and the materials partially sinter together into roughly shaped balls usually a few millimeters in size up to a few centimeters. This product is known as clinker and up to now has been used almost exclusively as an intermediate in the production of cement. When it has cooled it is then ground to a fine powder and some gypsum is added to give a final product known as Portland cement. Thus articles according to the invention may be moulded from (a) clinker, gypsum and lime, (b) OPC and clinker or (c) OPC.

Particularly suitable filter treatment materials are white ordinary Portland cement (OPC), white OPC cement clinker and combinations thereof. Clinker for forming such cements is kept as low as possible in transition metals e.g. chromium, manganese, iron, copper, vanadium, nickel and titanium and e.g. Cr₂O₃ is kept below 0.003% or in some embodiments 0.005, Mn₂O₃ is kept below 0.03%, and Fe₂O₃ is kept below 0.35% in the clinker or in some embodiments below 0.5%, the iron being reduced to Fe(II) to avoid discoloration of the cement. Limestone used in cement manufacture usually contains 0.3-1% Fe₂O₃, whereas levels below 0.1% are sought in limestone for white OPC manufacture, levels ≦ about 0.3 wt % being desirable and BaO levels of ≦ about 0.02-0.03 wt % also being desirable since excessive barium can cause cracking Free magnetic iron is preferably present in amounts ≦0.005 wt %, excessive amounts of free magnetic iron in some embodiments causing flaking on the back face of the moulded articles. Apart from the white color which gives rise to products which are aesthetically pleasing and promote food industry and final customer confidence, the low transition metal content helps to minimize leaching of undesirable ionic species into the oil, especially iron and aluminum. Furthermore white OPC and white cement clinker contain relatively few iron and copper sites which can accelerate oxidation processes within the oil. White OPC clinker e.g. from Aalborg (which is 97% ground clinker plus lime) has the following composition with phases represented as Bogue composition:

| | |
|---|---|
| C₃S | 65.0% |
| C₂S | 21.0% |
| C₃A | 5.0% |
| C₄AF | 1.0% |
| CaSO₄ | 0% |

Production of cement from clinker involves grinding and addition of 2-10 wt % CaSO₄. Aalborg white OPC has added calcium sulfate and has the following calculated Bogue composition (corrected to free lime content):

| | |
|---|---|
| C₃S | 66.04% |
| C₂S | 20.1% |
| C₃A | 4.64% |
| C₄AF | 1.04% |
| CaSO₄ | 3.45% |

Lime and gypsum in OPC will be varied by manufacturers depending on the available starting materials for cement manufacture in order to give industry standard reactivity. However, contents (wt %) may be as indicated below and the gypsum content being calculated from the SO₃ figure

| | Min | Max | Av | Allborg |
|---|---|---|---|---|
| Lime - Ca(OH)₂ | 0.03 | 3.68 | 1.243 | 2.10 |
| Gypsum - SO₃ | 0.0 | 5.35 | 2.58 | 2.58 |
| Gypsum - CaSO₄ | 0.0 | 9.15 | 4.41 | 3.47 |

Thus the present articles may be made from (a) white OPC clinker, gypsum and lime, (b) white OPC clinker and white OPC or (c) white OPC. The present articles may be made from a mixture of OPC and OPC clinker, the clinker being the major component. In embodiments the mixture is derived from OPC 15-35 wt % of (OPC+clinker) and clinker 65-85 wt % of (OPC+clinker), e.g. in one embodiment about 25 wt % of (OPC+clinker) and clinker about 75 wt % of (OPC+clinker) and in a further embodiment OPC about 20 wt % of (OPC+clinker) and clinker about 80 wt % of (OPC+clinker). It will be appreciated that the OPC and OPC clinker should be thoroughly mixed as with a mechanical mixer for optimum properties of the moulded article.

Where OPC and/or OPC clinker are used these may together comprise 100 wt % of the treatment material (apart from incidental ingredients as aforesaid) or they may comprise ≧50 wt %, typically ≧75 wt %, more typically ≧90 wt % of the treatment material. The further ingredients that may be used in combination with OPC, OPC clinker or a mixture thereof may be selected from calcium silicate, magnesium silicate, feldspars (natural) (albite), zeolites (natural & synthetic) (Na & Ca forms), silica (amorphous & crystalline)/sand, wollastonite, calcium hydroxide, alumina (hydrated), aluminium silicates, clays (bentonite, perlite), pillared clays, activated clays/earths, talcs/kaolinite, other silicate minerals (amphiboles, granite porphyry, rhyolite, agalmatolite, porphyry, attapulgite) etc. A further material that may be used according to the invention as treatment material with and without OPC and clinker is calcium silicate. However, the applicants have tested forms of calcium silicate as well as titanium oxide (see above) as additives, but these failed to provide any across the board advantage from a simple 2-material powder mix. Other incidental ingredients that may be added to OPC or OPC clinker, or to white OPC or white OPC clinker, include titania (TiO₂) typically in an amount of 1-2 wt % to promote whiteness and strength and/or silica typically in an amount of 1-2 wt % to promote strength. It is desirable, however, to select materials that are compatible in particle size to the cementitious materials e.g. clinker and OPC. For example, incorporation of TiO₂ may lead to a significant reduction in effectiveness, probably because pigment grade TiO₂ has a particle size of 0.25 μm and is effective to at least partly block the internal structure of the material.

Various fillers and aggregates may also be included in the mouldable compositions including sand, clay, silica sand and other inorganic materials. However, the use of fillers of this kind is not preferred.

The cement clinker as supplied is of particle size 2-20 mm and is milled to a similar particle size distribution to the cement e.g. to a nominal size of about 14.5 μm.

It is preferred where possible to start with clinker which has a relatively narrow distribution of particle size because unevenness in particle size distribution is reflected in unevenness in the particle size distribution of the resulting milled product. The closer the particle size distributions are of the OPC and the OPC clinker the less well-packed the resulting particles will be and hence the higher the porosity of the resulting cast or moulded article. PSD's of the cement and clinker may be in the range d10 2-3.5 μm, d50 12-17 μm and d90 35-100 μm.

Unmilled clinker, being of relatively large particle size is relatively insensitive to moisture and can be stored in air e.g. in sacks or bags, although storage should be under dry conditions. After milling moisture sensitivity is increased, and if the milled clinker absorbs moisture then hydrated phases may start to appear which may be harmful to the properties of the final product. For that reason either the clinker should be used immediately after milling or it should be stored in moisture-impermeable bags or containers e.g. bags lined with polyethylene. Similarly OPC is liable to deteriorate in storage owing to the presence of moisture and should be preserved dry prior to use.

CaSO₄ in OPC acts as a retardant and extends setting time, and in the present mixtures its proportion is lower than usual. For that reason pastes made from these clinker-rich mixtures have a relatively short working life after addition of water e.g. about 30 minutes at ambient temperatures. Some extension of working life may be obtained by agitation and by cooling the water used to form the cement paste, by external cooling of the paste during and after addition of water and/or by adding compatible set retarders.

In a variant use of OPC may be omitted and calcium sulfate and optionally lime may simply be added to clinker e.g. in 25 wt % of the normal amounts. Mixing at the dry powder stage may be facilitated by the fact that the dry powder is in some embodiments added gradually to a vortex of stirred water and formed into paste.

The hydraulic reaction of cement powder with water is complex. The component oxides shown in the table above combine to from four main compounds. These are

| | |
|---|---|
| C₃S, Tricalcium silicate | 3CaO•SiO₂ |
| C₂S, Dicalcium silicate | 2CaO•SiO₂ |
| C₃A, Tricalcium aluminate | 3CaO•Al₂O₃ |
| C₄AF, Tetracalcium aluminoferrite | 4CaO•Al₂O₃•Fe₂O₃ |

These compounds react with water to form calcium hydroxide and hydration products generally known as gel. One relatively fast reaction which causes setting and strength development is the reaction of tricalcium silicate which is the major and characteristic mineral in Portland cement with water to give the so-called C—S—H phase of cement according to the equation:

2Ca₃SiO₅+6H₂O→3CaO.2SiO₂.3H₂O+3Ca(OH)₂.

A further reaction which gives rise to “late” strength in cement is the reaction of dicalcium silicate with water also to form the C—S—H phase of cement:

2Ca₂SiO₄+4H₂O→3CaO.2SiO₂.3H₂O+Ca(OH)₂.

Gypsum is also a hydraulically settable binder that can be hydrated to form a hardened binding agent. One hydratable form of gypsum is calcium sulphate hemihydrate, commonly known as gypsum hemihydrate. The hydrated form of gypsum is calcium sulphate dihydrate, commonly known as gypsum dihydrate. Calcium sulphate hemihydrate can also be mixed with calcium sulphate anhydride, commonly known as “gypsum anhydrite” or simply “anhydrite.” Although gypsum binders or other hydraulically settable binders such as calcium oxide are generally not as strong as hydraulic cement, in some applications high strength may not be as important as other characteristics e.g., the rate of hardening. Gypsum hemihydrate hardens much more rapidly than traditional cements and in some embodiments may attain most of its ultimate strength within about 30 minutes. It may be used alone or in combination with other hydraulically settable materials. For example, adding gypsum hemihydrate to a hydraulically settable mixture containing hydraulic cement as a binder yields a mixture having a much lower water-to-cement ratio and, hence, higher strength.

Various fillers and aggregates may also be included in the mouldable compositions (e.g. to form concrete) including sand, natural gravel, crushed stone, clay, silica sand and other inorganic materials that are normally combined with cement.

An important aspect of compositions for moulding is water content. By definition, water is an essential component of a hydraulically settable material. The hydration reaction between hydraulic binder and water yields reaction products that give the hydraulically settable materials the ability to set up and develop strength. The preferred amount of added water within any given application is primarily dependent upon several variables, e.g. (a) the amount of water required to react with and hydrate the binder, (b) the amount of water required to give the hydraulically settable composition the necessary rheological properties and workability, and (c) the amount of water needed, where porosity is aimed at, to achieve a desired level of porosity. In order for the composition to have adequate workability, water must generally be included in quantities sufficient to wet each of the components and also to at least partially fill the interstices or voids between the particles e.g., of binder and aggregate if present. Furthermore the amount of water should in most cases be sufficient that there are no domains of the moulded product where unreacted cement remains. In some embodiments the amount of water is such that when the paste or other composition has been introduced into the mould, a faint sheen of water is apparent on the upper or exposed surface of the composition, but the amount of water is insufficient that relative movement of the particles is too free leading to a runny mixture that is difficult to control, or that a free-flowing layer of water develops on the composition. The appropriate solids to water ratio for any composition and end product properties will vary depending on the materials used and the fineness of the particles present, a fine mixture generally requiring a greater relative amount of water, and for each case needs to be determined by experimental trial.

Stoichiometric hydration requires a ratio of water to cement of about 25 wt % (on the basis that OPC+clinker=100 wt %), but it is standard practice for workability to add water in excess of that required for hydration e.g. in amounts of 30-42 wt % e.g. 32-37 wt %, in some embodiments about 35 wt %. Cement solids have a specific gravity of about 3 so that if a paste is formed with more water than is stoichiometric and no water is lost during the curing process the resulting cured cement article will have a porosity that is significantly greater than would be expected simply on comparison of the weights of the ingredients added. In some embodiments the OPC:clinker ratio may be from 0.176 to 0.667 and the solids:water ratio may be from 0.176 to 0.667.

It is desirable to use demineralised water for hydration and for subsequent process tasks e.g. washing as described below.

A “hydrated” or “cured” hydraulically settable composition refers to a level of substantial water-catalysed reaction which is sufficient to produce a hydraulically settable product having a substantial amount of its potential or final maximum strength. Nevertheless, such materials may continue to hydrate long after they have attained significant hardness and a substantial amount of their final maximum strength.

Amounts of material to be moulded may be is of mass 50 g-10 kg, e.g. 250 g-2.5 kg and in some embodiments ˜300 g. The resulting articles may be generally planar e.g. a disc, rectangle or other polygon in shape and may be formed with one or more through-holes for increasing effective surface area. Other articles may be of more complex shapes e.g. radiants for gas fires.

A material in its green state indicates that it has cured sufficiently for form stability but has yet to achieve much of its final strength.

### Moulds

Embodiments of the present process employ a flexible mould e.g. of cavity size up to 300 mm×300 mm×150 mm that is manufactured from inexpensive plastics materials by injection moulding, the moulds being inexpensive to manufacture and therefore needing only a limited mould lifespan. This has the advantages of quick time to market, low unit cost, simple change management through natural wastage, easier cleaning and lower impact on the product cost, enabling products to manufactured at a lower price and in greater variety. Many of the mould plastics can be reground and recycled to manufacture further moulds once the moulds have worn out and been replaced or used for other plastic moulded products. The moulds should be flexible enough to enable them to be distorted through externally applied forces e.g. manual pressure or pressure from a hand or other tool to facilitate separation between mould and the casting without being too weak to support the mass of the cast component and thus create a distorted or inaccurate moulded component. As an alternative the moulds may be formed from sheet by a thermoforming e.g. vacuum forming process. Embodiments of the mould have a generally planar mould cavity for moulding generally planar articles as mentioned above and may have an open face that provides for unobstructed removal of the shaped article after release by deformation of the mould. Internal features of the mould may be drafted towards the open face for facilitating removal of the shaped article e.g. at an angle of 1-10°, and where the internal features include cores for forming through-holes in the shaped article, said cores may have draft angles of about 6°.

Low temperature, e.g. 0-120° C., casting and curing processes may use low-temperature rated plastics e.g. a flexible polyalkylene e.g. a flexible polyethylene. A particularly suitable low cost low surface-energy material is LDPE which has more extensive branching resulting in less compact molecular structures and lower mechanical strength, than other polyethylenes and which may be injection moulded at very low cost and with low wall thicknesses, e.g. 0.5-3 mm e.g. ˜1.6 mm. Suitable materials have a Shore D hardness of 70-90 and surface energy at 20° C. of ≦36 mN/m e.g. about 35.5. In some embodiments the surface energy is substantially wholly dispersive with minimal polar contribution or other contribution from non-dispersive forces. LDPE has water adsorption <0.01% which is about half that of polypropylene. HDPE also displays a similar water adsorption rate but lacks the flexibility of LDPE. The resulting mould may exhibit sufficient rigidity to accurately form a desired casting without distortion and without external support e.g. a mother mould but also a measure of flexibility that allows simple manual or mechanical de-moulding and ejection of the component on deliberate distortion of the mould. Mechanical pusher rods, stripper plates and other expensive components normally associated with alloy moulds or other rigid mould designs are not needed. Other materials that could be used include LLDPE and generic polypropylene. Generic plastics with similar properties may be substituted specialist plastics such as DuPont Hytrel, Zytel and similar nylon based materials depending on the size and process requirements of the mould. Modifications to cast component feature detail may be easily effected by alteration to the injection mould tooling with inserts or direct machining of feature alterations in the mould and then reproduced in high volume by standard injection moulding processes.

If a mould is to be discarded after a single use a preferred alternative manufacturing method for the mould is thermoforming (i.e. deformation of a sheet of the plastics material), which may include pressure forming, vacuum forming or forming using a combination of pressure and vacuum. In this case a vacuum formed mould may be reproduced at exceedingly low cost with a very thin wall and stripped away like consumer “blister pack” packaging which may be discarded and preferably recycled for re-use.

An embodiment of the mould in LDPE or other suitable plastics material for a 3×5 aperture generally rectangular briquette has a base flange 12 for distributing the weight of cement paste or slurry and for supporting sidewalls 10. A top surface 3 of the sidewalls provides a reference surface for the mould cavity 17 Underside support feet 14 prevent distortion-location and use depend on mould support requirements for any specific shaped cast component. Mould cavity 17 is provided for casting into and for providing provide the component external profile, Upstand features 18 create depth detail and any required apertures. Tooling holes 15 provide positioning registration for regular arraying of the moulds in a horizontal matrix on a baseboard with cooperating location pegs for mould-filling (not shown) and for vertical registration with other cooperating system components if stacked vertically. Stiffening ribs 16 are optionally provided to facilitate ejection of an injection moulded mould component when manufactured with thin a wall section that is liable to flex during ejection if ejector pins are provided in the corners of the component. To create through-apertures within the moulded part the upstand features 18 are preferably coplanar or above mould top face 13 to which face the mould is normally filled and in many embodiments wiped to create a flat cast component surface. All Sidewalls 10 and the internal cavity 17 and internal upstand features 18 are drafted towards the top face 13 to facilitate ejection off the injection mould or thermoform tooling as well as to facilitate demoulding of the component cast within this mould.

Moulds may be designed to be filled fully to the open “top” surface and then screeded to create a flat cast product face. Alternatively the mould may be deeper than the intended final product and may be filled to a predetermined lower volume by dispensing an exact volume or to an exact level required for the product to create a desired cast product thickness. The second method has the advantages that it is simpler, there is no screeding step and consequential waste of material, no screed mechanism need be provided, and the operations of mould and process line and filling station cleaning are reduced. For removal of the article the mould may be inverted and may be removed manually or by an ejection tool that may e.g. push down on what are then downwardly-facing regions of the mould defining through-holes in the article.

### Stacking Components

To facilitate curing within the mould to achieve adequate robustness to allow demoulding of the component without breakage or distortion it may in some embodiments be desirable to hydrate the curing cement product through provision of an ambient high relative humidity. That can be achieved either by covering the moulds with an impervious (typically polyethylene) sheet or preferably by placement in a closed chamber with a controlled source of moisture to provide the necessary RH and appropriate temperature to accelerate cure to achieve the desired product parameters. When employing a closed chamber with a controlled RH, to simplify handling, a stacking system is envisaged that provides an interlocking framework permitting stable multiple stacking of moulds yet allowing access of essential moisture for the cement hydration process and egress of any process gases (normally CO2) to prevent mould distortion through development of over-pressures between stacked moulds.

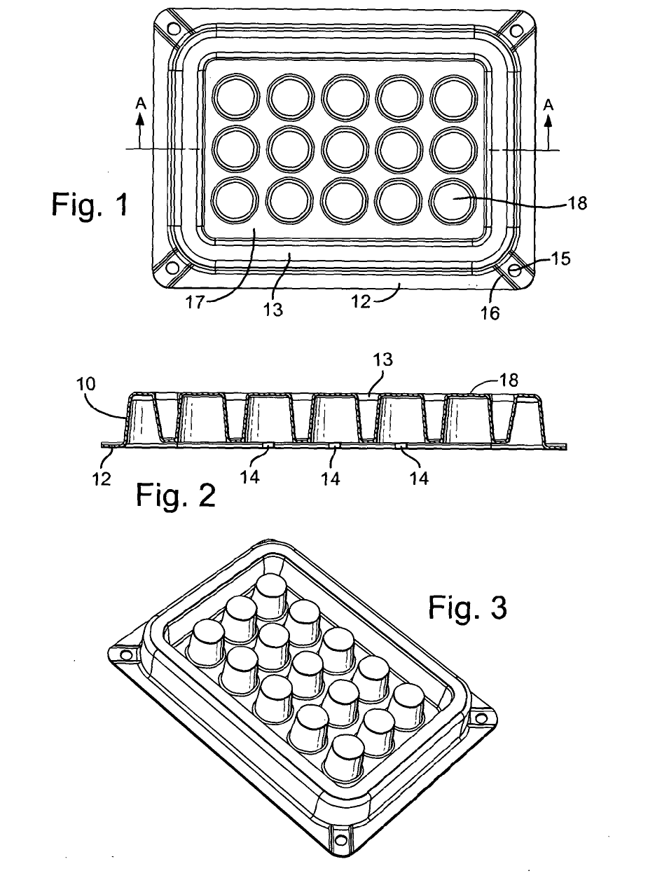

There is provided a rectangular plastic frame that sits on the flanged base of a mould as shown in FIGS. 1-3 providing an interlock feature to provide keying of the stacked moulds, a separator feature that fixes the vertical distance apart to facilitate a body of high RH air above the mould face and vent slot features in the sidewalls to provide access to high RH air and for the removal of reaction gases, typically CO₂.

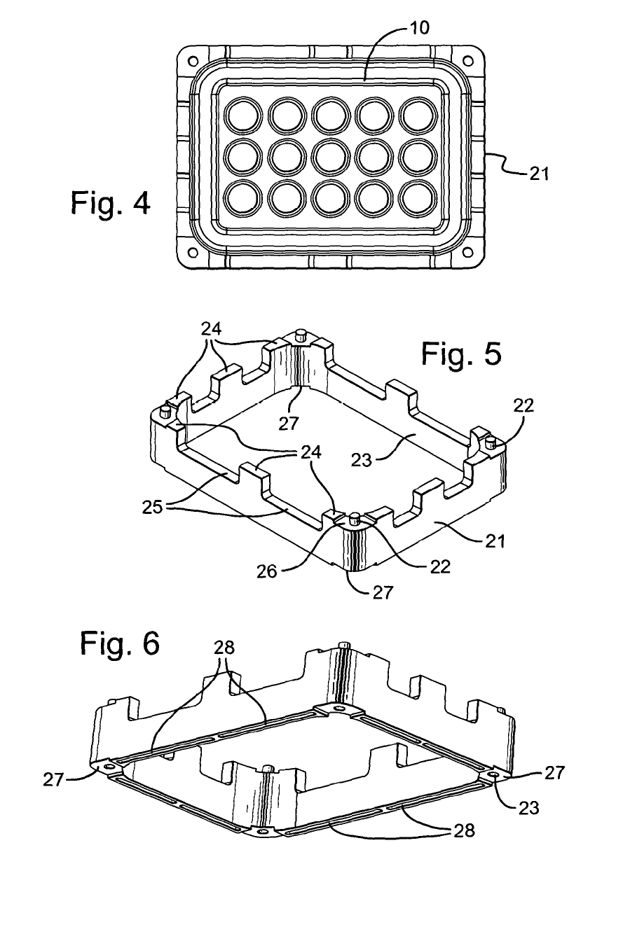

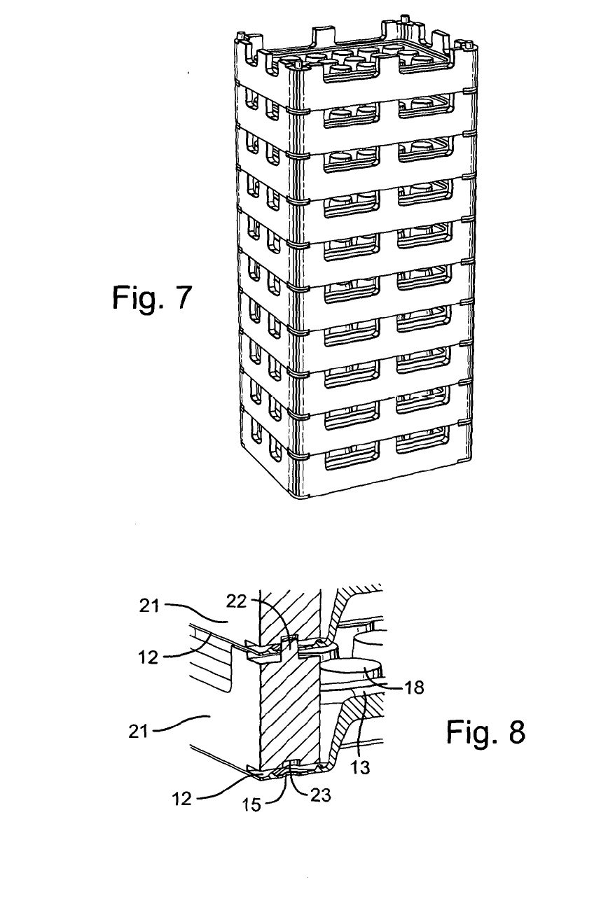

With reference to FIGS. 4-8, a mould 14 as shown in FIGS. 1-3 is filled and laid down on a flat surface on Mould Flanges 20. Main frame 21 is laid on mould 24 such that the inner profile 23 of frame 21 cooperates with the upstanding body features of mould 24 to locate and orient the frame in the horizontal plane. A bottom land 29 of the frame rests on top of the first mould flange 20 and traps it in place, this effect being increased as every further mould and frame is added to the stack.

Frame 21 has a bottom corner relief notch 27 located in each of the four underside corners to provide clearance to stiffening mould ribs 21 located in the corner flanges of the mould 24. Frame 21 provides four upstand pegs 22, one in each corner, that register and cooperate with mould corner holes 22, while the mould flange 20 is supported on upstand support lands 24 distributed around the frame 21 top surface. Vents slots 25 are provided around frame 21 to permit a free flow of air—in this application often with an introduced level of high relative humidity e.g. ≧95% RH. Upstand pegs 22 project above the upstand support lands 24 and they are taller than the thickness of mould flange 20 to provide registration for the next frame 21 and mould 24 to be located on top of the current stack. Peg receiving holes 23 in the bottom corners of the upper frame 21 cooperate with the upstand pegs 22 of the lower frame 21 to provide good registration and stability to the stack.

Flexible plastic moulds often take a set or display some small corner flange distortion and for this reason top corner relief notches 26 are provided in each corner to allow for some tilting of the mould flanges 20 in the corners without affecting stack stability. Bottom mass relief slots 28 of the general form shown provide means of reducing the overall mass of usually rigid plastic employed in manufacture of the frame 21.

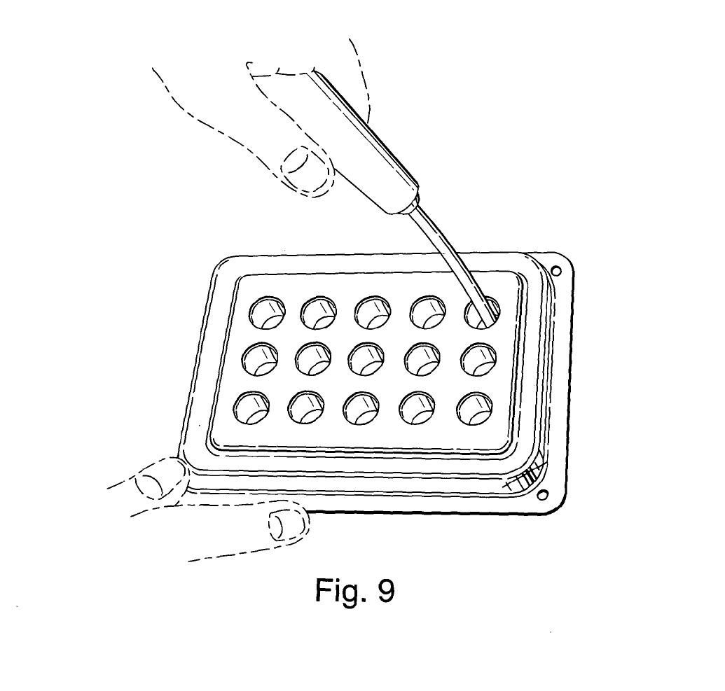

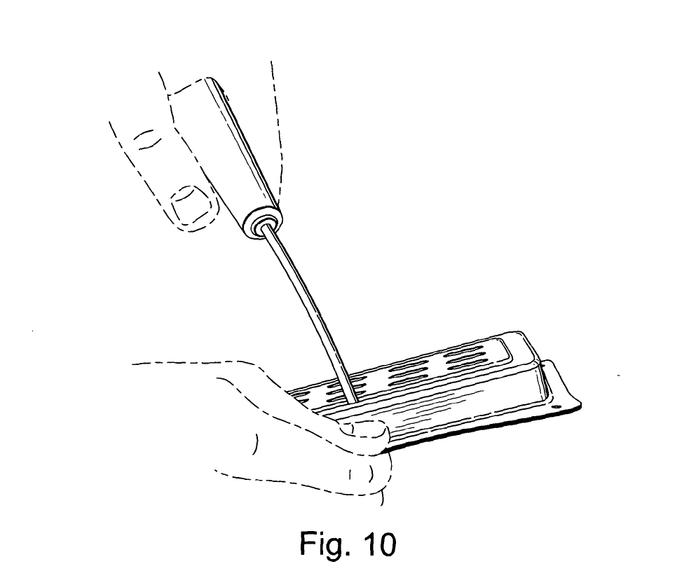

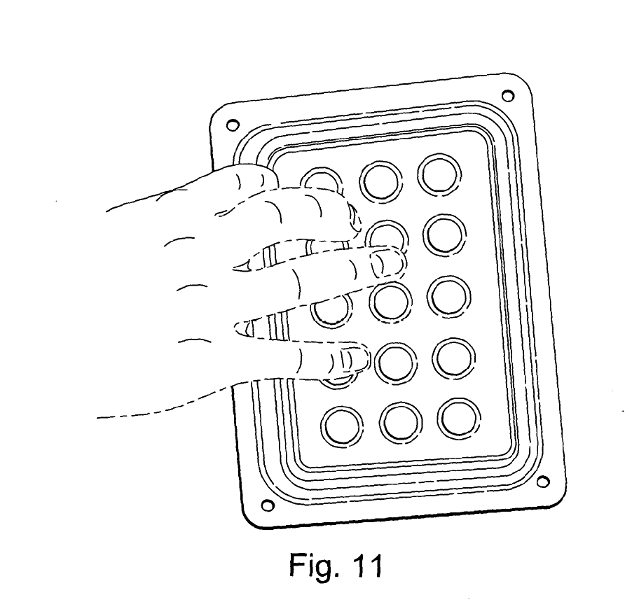

FIGS. 9-11 show manufacture of a practical shaped article and also an article after removal from the mould. The circular upstands can be pushed one at a time with fingers or using a tool as shown until a small “click” is heard as the mould releases from the casting. The sidewalls are deformed or “sprung” away from the casting and air is blown down the gap with a small airline nozzle which releases the vacuum between the mould and the green or hardened shaped article within it and lifts and loosens the article in the mould cavity. In the disclosed embodiment this is continued around all four edges of the mould after which the mould is inverted and the shaped article is free to come out of the mould. The mould may be lifted away from the shaped article which may then be inspected.

It will appreciated that the load of each mould and the composition with which it is filled is transferred to its frame, and the loads are then transferred from one frame to another so that the load path does not pass through the individual moulds. Load is transferred through the frames to the lowest frame to prevent mould distortion.

### Representative Processes

In an embodiment the following procedure may be used. 80 parts by weight of ground clinker and 20 parts by weight of OPC are dry mixed e.g. in a drum mixer and 35 parts by weight of demineralised water is added. This amount of water is a general guideline and the weight of water will vary according to solubility of the dry materials which in turn may vary depending on the particle size. A test volume measurement for the amount of water required to achieve a correctly hydrated slurry or paste must be performed. Pre-mix powder slowly to a vortex of water in a mechanical mixer and mixing is continued until the slurry is of an even consistency. The amount of water should be such that the paste or slurry is not too runny but when placed in the mould a 2 hrs water sheen is apparent on the free surface of the mix.

When mixing is complete, the individual moulds may be filled as follows. Moulds are placed on a vibrating table in array of e.g. four moulds. Using a jug ˜0.5 kg of slurry or paste is removed at each time and each mould is slowly filled, the nominal final dried product mass in an embodiment being ˜330 g. The moulds in the array may be filled to ˜75% full each (˜225 cc) and then topped up with the balance of ˜75 cc while the vibration is applied. When the four moulds in the array have been filled, vibration may be continued for a short period to allow any remaining air to escape. The moulds are then covered with polyethylene sheet and allowed to reach initial set with restricted escape of moisture. In an alternative procedure the moulds are simply tapped with an impact hammer to assist escape of air and to assist in levelling, there being little or no applied vibration which would otherwise promote settling of the paste and give rise to an article of reduced porosity.

The moulds after initial set are then inserted into frames and the frames are stacked and placed in a humidification chamber for e.g. ˜4 hrs at e.g. ˜95% RH. Green blocks are then de-moulded by flexing the moulds, placed into trays and returned to the humidification chamber for a second period of ˜4 hrs at e.g. ˜95% RH. The product is them immersed in demineralised water for e.g. ˜2 hrs to remove any loose material, surface fines and cure any unreacted material. It is then placed in racks in an oven at 110° C. (RH nominally ambient) for e.g. ˜12 hrs, raising the temperature from room temperature at a rate of 10° C. every 5 minutes. The product is then cooled and packed e.g. in cardboard boxes with plastics sheet separators between successive layers of product.

In another procedure clinker and OPC both stored in a dry state without the possibility of moisture ingress and having following measured PSDs (all in μm) were employed and were formed into a pre-mix powder using a dry powder mixer:

| | Source | | |
|---|---|---|---|
| | d10 | d50 | d90 |
| OPC: | 2.08 | 8.72 | 36.32 |
| New clinker: | 2-3 | 13-15 | 40-60 |

Pastes were made up by mixing clinker and OPC pre-mixes and demineralised water in the proportions indicated below, the water being placed in a mechanical mixer and pre-mix powder being added slowly to the vortex of the water, mixing being continued until an even slurry was obtained.

| | Old | | | Modified | | | | |
|---|---|---|---|---|---|---|---|---|
| | (Preferred) | | | (P7) | | With new clinker | | |
| OPC | 17.86% | 25.0% | OPC | 14.81% | 20.0% | OPC | 18.39% | 24.9% |
| Clinker | 53.57% | 75.0% | Clinker | 59.26% | 80.0% | Clinker | 55.50% | 75.1% |
| Water | 28.57% | 40.0% | Water | 25.93% | 35.0% | Water | 26.11% | 35.3% |
| Total | 100.00% | | Total | 100.00% | | Total | 100.00% | |

Each paste was filled into a mould as described above, but the mould was not mounted on a vibration table but instead the filled mould was tapped with a flat-edged piece of wood or metal to remove air bubbles with a minimum of agitation so as to minimise separation of particles within the paste. Each mould was deeper than the intended final product and was filled to a predetermined lower volume by dispensing an exact volume or to an exact level required for the product to create a desired cast product thickness. The filled moulds were then maintained as close as possible at 100% RH in a humidity chamber having a floor temperature of 28° C. and a top temperature of 32° C., the moulds being located in a mid-height region where the temperature was about 30° C., and were allowed to stand for 24 hours to achieve initial set, the slightly elevated temperature being selected for ease of control of temperature and humidity and also to slightly speed setting. After initial set, the moulds were placed in a humidity chamber under 95-100% RH and at 40° C. for four hours to complete in-moulds curing and achieve green strength.

De-moulding was by inverting the mould with the article present in it and depressing the upstand features 18 e.g. using push rods or a release tool to break the adhesion between these features and the adjoining surfaces of the moulded article, after which the sidewalls 10 were flexed if necessary to break the adhesion between them and the moulded article, which could then be removed, optionally with slight finger pressure on the mould. Where a release tool is employed, it may advantageously operate on only some of the upstand features 18, e.g. the two outer rows of 5 upstand features but not those of the central row. Compared to the first method the increased mould depth facilitated release of the moulded article.

The de-moulded products were then placed on production racks and washed/soaked in demineralised water at ambient temperature for >15 minutes to promote curing of unreacted cement and to remove loose material. It is believed that the wash/soak step immediately following de-moulding was possible at least partly as a result of the slightly elevated temperature in the initial humidity chamber as compared to Example 1. The washed products were then placed in an oven, heated to 120° C. at a rate of 10° C. every 5 minutes and dried at 120° C. for 4 hours. The dried articles were allowed to cool in a dry environment and packaged in moisture-=resistant material immediately after drying.

The used moulds were cleaned in a sonic bath filled with deionised water and/or citric acid solution for up to 2 hours, washed with deionised water and dried ready for re-use.

The product may be a porous article hydraulically moulded from (a) clinker, gypsum and lime, (b) OPC and clinker or (c) OPC (e.g. (a) white OPC clinker, gypsum and lime, (b) white OPC clinker and white OPC or (c) white OPC), said article having a face that was adjacent the mould with a nominally even pore distribution of 25-35% by area with pore sizes 2-10 μm, a mid-depth having <1-2 μm pores evenly distributed and representing 20-25% by area and a face furthest from the mould having 2-5 μm pores representing 20-25% of the surface by area, and having an oil absorption measurable at an oil temperature of 36-40° C. and on drying at 120° C. of 14-20 wt %. In embodiments of this article, the face furthest from the mould also has inwardly extending 5-50 μm fissures and a layer of calcite crystals is apparent at the face furthest from the mould. It may have a water absorption measurable after drying at 120° C. of 26-30 wt %, a 3-point bend strength of 5-9.5 Mpa and a bulk density of 1.6-1.8. Embodiments when placed in cooking oil at frying temperature does not give rise to substantial foaming.

1-51. (canceled)

52. A method for casting a shaped article from hydraulically settable material which includes the steps of:
introducing the hydraulically settable material into a mould and allowing it to harden at least to a green state; and
removing the hardened material from the mould,
wherein the mould is of a flexible low surface energy thermoplastics material and removal is by deformation of portions at least of the mould.

53. The method of claim 52, wherein the shaped article is generally planar and the mould has an open face for introduction of the hydraulically settable material and providing no obstruction to removal of the article when the hydraulically settable material has hardened.

54. The method of claim 53, wherein the mould:
(a) has a cavity is of size up to 300 mm×300 mm×150 mm; and/or
(c) has internal features drafted towards the open face for facilitating removal of the shaped article; and/or
(d) has internal features drafted at an angle of 1-10°; and/or
(e) has internal features including cores for forming through-holes in the shaped article, said cores having draft angles of about 6°; and/or
(f) has wall thickness 0.5-3 mm; and/or
(g) has wall thickness ˜1.6 mm; and/or
(h) is an injection moulding; and/or
(i) is a thermoform; and/or
(j) is of material having a Shore D hardness of 70-90; and/or
(k) is of a material having a surface energy of ˜28 mJm⁻²; and/or
(l) is of a polyalkylene; and/or
(m) is of polyethylene; and/or
(n) is of LDPE; and/or
(o) is an injection moulding or has been thermoformed from sheet

55. The method of claim 53, wherein the shaped article:
(a) has at least two through-holes for providing surface area; and/or
(a) has 10-40 through holes; and/or
(c) has 15 through holes; and/or
(d) is of mass 50 g-10 kg, e.g. 250 g-2.5 kg, e.g. ˜300 g.

56. The method of claim 52, wherein the article is removed while in a green state.

57. The method of claim 52, wherein casting is in the absence of release agent applied to the mould.

58. The method of claim 52, wherein the hydraulically settable material is paste, or is a composition comprising paste and at least one filler.

59. The method of claim 52, wherein the hydraulically settable material is (a) clinker, gypsum and lime, (b) clinker and OPC or (c) OPC.

60. The method of claim 59, wherein the moulded product:
(a) has a face that was adjacent the mould with a nominally even pore distribution of 25-35% by area with pore sizes 2-10 μm, a mid-depth having <1-2 μm pores evenly distributed and representing 20-25% by area and a face furthest from the mould having 2-5 μm pores representing 20-25% of the surface by area, and an oil absorption measurable at an oil temperature of 36-40° C. and on drying at 120° C. of 14-20 wt %; and/or
(b) the face furthest from the mould also has inwardly extending 5-50 μm fissures; and/or
(c) has a layer of calcite crystals is apparent at the face furthest from the mould; and/or
(d) has a water absorption measurable after drying at 120° C. of 26-30 wt %; and/or
(e) has a 3-point bend strength of 5-9.5 Mpa; and/or
(f) has a bulk density of 1.6-1.8; and/or
(g) has the property that when placed in cooking oil at frying temperature it does not give rise to substantial foaming.

61. The method of claim 52, wherein:
(a) the moulds are placed in a humidification chamber during hardening; and/or
(b) moulds filled with hydraulically settable material are placed in frames and stacked, the stacked frames having openings allowing air/water vapour circulation to the hydraulically settable material;

62. A frame for supporting a plastics mould for complex shapes in cement paste, said frame being configured to permit vertical stacking of the moulds.

63. A frame according to claim 62, having any of the following features
(a) formations for cooperation with formations of the mould for retaining the mould in position therein; and/or
(b) plug and socket formations on opposed upper and lower faces for cooperation with overlying and underlying frames of a stack; and/or
(c) plugs forming part of the frame positioned for location in apertures of the mould; and/or
(d) the frame is of plastics material; and/or
(e) the frame is an injection moulding or is vacuum formed; and/or
(f) the frame forms part of a stack comprising flexible plastics moulds to permit de-moulding of articles whilst in a green state and frames for supporting the moulds, said frames being configured to stand one on another and permit vertical stacking of the plastics moulds; and/or
(g) the frames are apertured for allowing air/water vapour circulation to the mould face in a hydration chamber.

64. A method for casting or otherwise forming of a shaped article from a settable material requiring a flexible mould for ease of release which includes the steps of:
introducing the settable material into a mould and allowing it to harden; and
removing the hardened material from the mould,
wherein the mould is of a flexible low surface energy thermoplastics material and removal is by deformation of portions at least of the mould.

65. The method of claim 64, wherein the mould is of LDPE.

66. The method of claim 64, wherein the mould has an open face through which the article is removable after release without further mould deformation.

67. The method of claim 64, wherein the settable material is hardenable by cooling.

68. The method of claim 64, wherein the settable material is an inorganic material that is hardenable by curing.

69. The method of claim 64, wherein the settable material is an organic material that is hardenable by curing.

70. The method of claim 64, wherein the settable material is a solvent-based material.

71. The method of claim 64, wherein the settable material is a water-based material.
